(19) United States
(12) Patent Application Publication
(10) Pub. No.: US 2025/0323480 A1
(43) Pub. Date: Oct. 16, 2025

(54) JUNCTION BOX FOR TRAILER WIRING

(71) Applicant: Krystina McNamara, West Haven, UT (US)

(72) Inventor: Krystina McNamara, West Haven, UT (US)

(21) Appl. No.: 19/040,773

(22) Filed: Jan. 29, 2025

Related U.S. Application Data
(60) Provisional application No. 63/633,452, filed on Apr. 12, 2024.

(51) Int. Cl. H02G 3/14; H02G 3/08; H02G 3/10

(52) U.S. Cl. CPC H02G 3/14; H02G 3/083; H02G 3/088; H02G 3/10

(57) ABSTRACT

Disclosed herein is a junction box for housing wiring of a trailer. The junction box includes a base, within which the wiring is securable. The base includes a closed bottom, at least three sides connected to the closed bottom, an open top, and a lid engagement feature. At least one of the at least three sides includes one or more wire pass-throughs. The junction box also includes a lid, including a base engagement feature that is selectively releasably engageable with the lid engagement feature of the base to enclose an interior cavity of the junction box when the lid is in a closed position.

### CROSS-REFERENCE TO RELATED APPLICATION

This application claims the benefit of U.S. Provisional Patent Application No. 63/633,452, filed Apr. 12, 2024, which is incorporated herein by reference in its entirety.

### FIELD

The present disclosure relates generally to protecting and storing wiring harness connections, and more particularly to a junction box for trailer wiring.

### BACKGROUND

A junction box is an electrical enclosure for housing one or more wiring connections. The junction box protects the wiring connections, which can include components vulnerable to damage, from environmental conditions and accidental contact. Junction boxes are commonly used in outdoor applications, such as on a trailer, where wiring connections are required to be enclosed for various reasons, such as user safety, securing wiring connections, and protecting wiring connections from environmental elements, such as water.

### SUMMARY

From the foregoing discussion, it should be apparent that a need exists for an apparatus for an improved junction box. Beneficially, such an apparatus promotes easier access to trailer wiring secured within a junction box.

The subject matter of the present disclosure has been developed in response to the present state of the art, and in particular, in response to the problems and needs in the art that have not yet been fully solved by currently available junction boxes. Accordingly, the subject matter of the present disclosure has been developed to provide a junction box that overcomes at least some of the shortcomings of prior art junction boxes.

Disclosed herein is a junction box for housing wiring of a trailer. The junction box includes a base, within which the wiring is securable. The base includes a closed bottom, at least three sides connected to the closed bottom, an open top, and a lid engagement feature. At least one of the at least three sides includes one or more wire pass-throughs. The junction box also includes a lid, including a base engagement feature that is selectively releasably engageable with the lid engagement feature of the base to enclose an interior cavity of the junction box when the lid is in a closed position. The preceding subject matter of this paragraph characterizes example 1 of the present disclosure.

The lid engagement feature includes one of a tongue or a groove of a tongue-and-groove coupling, and the base engagement feature includes another one of the tongue or the groove of the tongue-and-groove coupling. The preceding subject matter of this paragraph characterizes example 2 of the present disclosure, wherein example 2 also includes the subject matter according to example 1, above.

The base engagement feature is at least one latch of a latch coupling, and the lid engagement feature is at least one catch corresponding to the at least one latch of the base engagement feature the pair combine to form a latch coupling. The preceding subject matter of this paragraph characterizes example 3 of the present disclosure, wherein example 3 also includes the subject matter according to any of examples 1-2, above.

The junction box further includes a hinge pivotally coupling the lid to the base, such that the lid is pivotable relative to the base between, and inclusive of, the closed position and an open position, in which the interior cavity is not enclosed. The preceding subject matter of this paragraph characterizes example 4 of the present disclosure, wherein example 4 also includes the subject matter according to any of examples 1-3, above.

The lid engagement feature is one of a tongue or a groove of a tongue-and-groove coupling, and the base engagement feature is another one of the tongue or the groove of the tongue-and-groove coupling. The preceding subject matter of this paragraph characterizes example 5 of the present disclosure, wherein example 5 also includes the subject matter according to any of examples 2-4, above.

The base engagement feature is at least one latch of a latch coupling, and the lid engagement feature is at least one catch corresponding to the at least one latch of the base engagement feature the pair combine to form a latch coupling. The preceding subject matter of this paragraph characterizes example 6 of the present disclosure, wherein example 6 also includes the subject matter according to any of examples 2-5, above.

The junction box further includes a locking mechanism configured to selectively lock the lid in the closed position. The preceding subject matter of this paragraph characterizes example 7 of the present disclosure, wherein example 7 also includes the subject matter according to any of examples 2-6, above.

The hinge includes a base knuckle fixed to the base and including a first channel, a lid knuckle fixed to the lid and including a second channel, and a pin extending through the first channel and the second channel to pivotally couple together the base knuckle and the lid knuckle. The pin defines a rotational axis of the hinge. The preceding subject matter of this paragraph characterizes example 8 of the present disclosure, wherein example 8 also includes the subject matter according to any of examples 2-7, above.

The hinge forms a one-piece monolithic construction and is co-molded with the base and the lid. The hinge spans from the base to the lid and comprises a flexible material that flexes as the lid pivots relative to the base. The preceding subject matter of this paragraph characterizes example 9 of the present disclosure, wherein example 9 also includes the subject matter according to any of examples 2-8, above.

The base further comprises at least one external securement tab configured to secure the junction box to a vehicle trailer. The preceding subject matter of this paragraph characterizes example 10 of the present disclosure, wherein example 10 also includes the subject matter according to any of examples 1-9, above.

The at least one external securement tab extends perpendicularly from at least one wall of the base. The preceding subject matter of this paragraph characterizes example 11 of the present disclosure, wherein example 11 also includes the subject matter according to any of examples 7-10, above.

The junction box further includes a grommet fixed within each one of at least one of the pass-throughs. The preceding subject matter of this paragraph characterizes example 12 of the present disclosure, wherein example 12 also includes the subject matter according to any of examples 1-11, above.

The base further includes at least one wire tensioner within the interior cavity. The preceding subject matter of this paragraph characterizes example 13 of the present disclosure, wherein example 13 also includes the subject matter according to any of examples 1-12, above.

The at least one wire tensioner includes at least one channel, which corresponds to the shape of the corresponding pass through and is vertically aligned with the corresponding pass through. The preceding subject matter of this paragraph characterizes example 14 of the present disclosure, wherein example 14 also includes the subject matter according to any of examples 10-13, above.

The junction box further includes a gasket positioned within the engagement groove. The preceding subject matter of this paragraph characterizes example 15 of the present disclosure, wherein example 15 also includes the subject matter according to any of examples 1-14, above.

Further disclosed herein is a system. The system includes a vehicle trailer, having at least one set of electrical components. The system also includes a junction box, coupled to the vehicle trailer and includes a base, within which the wiring is securable. The base comprises a closed bottom, at least three sides connected to the closed bottom, and an open top. At least one of the at least three sides has one or more wire pass-throughs. The junction box further includes a lid, engageable with the open top of the base to enclose an interior cavity of the junction box. The junction box also includes a lid-base retention system comprising a lid engagement feature and a base engagement feature. The lid engagement feature and the base engagement feature of the lid-base retention system are selectively releasably engageable to prevent the lid from opening relative to the base and to enclose the interior cavity when the lid is in the closed position. The junction box additionally includes trailer electrical components within the interior cavity. The system further includes at least one electrical cable passing through a corresponding one of the wire pass-throughs and electrically connected to at least one of the trailer electrical components. The preceding subject matter of this paragraph characterizes example 16 of the present disclosure.

The junction box further includes a hinge rotatably coupling the lid to the base, such that the lid is rotatable relative to the base between, and inclusive of, a closed position, in which the lid is engaged with the open top of the base. The preceding subject matter of this paragraph characterizes example 17 of the present disclosure, wherein example 17 also includes the subject matter according to example 16, above.

The hinge of the junction box includes a base knuckle fixed to the base and comprising a first channel, a lid knuckle fixed to the lid and comprising a second channel, and a pin extending through the first channel and the second channel to pivotally couple together the base knuckle and the lid knuckle. The pin defines a rotational axis of the hinge. The preceding subject matter of this paragraph characterizes example 18 of the present disclosure, wherein example 18 also includes the subject matter according to example 17, above.

The lid engagement feature is one of a tongue or a groove of a tongue-and-groove coupling. The base engagement feature is another one of the tongue or the groove of the tongue-and-groove coupling. The preceding subject matter of this paragraph characterizes example 19 of the present disclosure, wherein example 19 also includes the subject matter according to any of examples 16-18, above.

Additionally disclosed herein is a method for housing a trailer wiring system. The method includes moving a lid of a junction box away from an open top of a base of the junction box into an open position. In the open position, an interior cavity of the junction box is accessible through the open top of the base. The method also includes inserting a cable through a pass-through formed in the base. The method further includes securing the cable to a wire tensioner of the base, which is located within the interior cavity of the junction box. The method additionally includes moving the lid toward the base of the junction box, from the open position to a closed position. In the closed position the interior cavity of the junction box is not accessible through the open top of the base. The method additionally includes engaging a lid engagement feature of the base and a base engagement feature of the lid when the lid is in the closed position to selectively releasably retain the lid in the closed position relative to the base. The method also includes engaging a lid engagement feature of the base and a base engagement feature of the lid when the lid is in the closed position to selectively releasably retain the lid in the closed position relative to the base. The preceding subject matter of this paragraph characterizes example 20 of the present disclosure.

Reference throughout this specification to features, advantages, or similar language does not imply that all of the features and advantages that may be realized with the subject matter of the present disclosure should be or are in any single embodiment of the subject matter. Rather, language referring to the features and advantages is understood to mean that a specific feature, advantage, or characteristic described in connection with an embodiment is included in at least one embodiment of the subject matter of the present disclosure. Thus, discussion of the features and advantages, and similar language, throughout this specification may, but do not necessarily, refer to the same embodiment.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter of the present disclosure will be readily understood, a more particular description of the subject matter briefly described above will be rendered by reference to specific examples that are illustrated in the appended drawings. Understanding that these drawings depict only typical examples of the subject matter of the present disclosure and are not therefore to be considered to be limiting of its scope, the subject matter will be described and explained with additional specificity and detail through the use of the accompanying drawings, in which:

FIG. 1 is an isometric view of a hinged junction box, according to one or more examples of the present disclosure;

FIG. 2 is a front elevation view of the hinged junction box of FIG. 1, according to one or more examples of the present disclosure;

FIG. 3 is a front elevation view of the hinged junction box of FIG. 1, but shown with a grommet in a pass-through of the hinged junction box, according to one or more examples of the present disclosure;

FIG. 4 is a back elevation view of the hinged junction box of FIG. 1, according to one or more examples of the present disclosure;

FIG. 5 is a first angled elevation view of the hinged junction box of FIG. 1, according to one or more examples of the present disclosure;

FIG. 6 is a second angled elevation view of the hinged junction box of FIG. 1, according to one or more examples of the present disclosure;

FIG. 7 is a left side elevation view of the hinged junction box of FIG. 1, according to one or more examples of the present disclosure;

FIG. 8 is a right side elevation view of the hinged junction box of FIG. 1, according to one or more examples of the present disclosure;

FIG. 9 is another isometric view of the hinged junction box of FIG. 1, from a back side of the hinged junction box, according to one or more examples of the present disclosure;

FIG. 10 is yet another isometric view of the hinged junction box of FIG. 1, from a left side of the hinged junction box, according to one or more examples of the present disclosure;

FIG. 11 is a third angled elevation view of the hinged junction box of FIG. 1, according to one or more examples of the present disclosure;

FIG. 12 is an isometric view of the hinged junction box of FIG. 1, from a bottom of the hinged junction box, according to one or more examples of the present disclosure;

FIG. 13 is an isometric view of a lid of the hinged junction box of FIG. 1, showing an inside of the lid, according to one or more examples of the present disclosure;

FIG. 14 is an isometric view of a base of the hinged junction box of FIG. 1, showing an inside of the base, according to one or more examples of the present disclosure;

FIG. 15 is yet another isometric view the hinged junction box of FIG. 1, showing the hinged junction box in an open configuration, according to one or more examples of the present disclosure;

FIG. 16 is a cross-sectional right side elevation view of the hinged junction box of FIG. 1, taken along the line 16-16 in FIG. 1, according to one or more examples of the present disclosure;

FIG. 17 is a perspective view of a junction box system, showing a trailer frame, cables, and a hinged junction box of the system, and all shown from a view above the trailer, according to one or more examples of the present disclosure;

FIG. 18 is a perspective view of a junction box system, showing a trailer frame, cables, and a junction box of the system, and all shown from a view above the trailer, according to one or more examples of the present disclosure;

FIG. 19 is a bottom view of a junction box system, showing a trailer frame, cables, and a junction box of the system, and all shown from a view below the trailer, according to one or more examples of the present disclosure;

FIG. 20 is an isometric view of a hinged junction box, according to one or more examples of the present disclosure;

FIG. 21 is a left side elevation view of the hinged junction box of FIG. 20, according to one or more examples of the present disclosure;

FIG. 22 is a second isometric view of the hinged junction box of FIG. 20, according to one or more examples of the present disclosure;

FIG. 23 is a close-up cross-sectional side elevation view of a section A of the hinged junction box of FIG. 20, according to one or more examples of the present disclosure;

FIG. 24 is an isometric view of another junction box, according to one or more examples of the present disclosure;

FIG. 25 is a front elevation view of the junction box of FIG. 24, according to one or more examples of the present disclosure;

FIG. 26 is a front elevation view of the junction box of FIG. 24, but shown with a grommet in a pass-through of the junction box, according to one or more examples of the present disclosure;

FIG. 27 is a back elevation view of the junction box of FIG. 24, according to one or more examples of the present disclosure;

FIG. 28 is a first angled elevation view of the junction box of FIG. 24, according to one or more examples of the present disclosure;

FIG. 29 is a second angled elevation view of the junction box of FIG. 24, according to one or more examples of the present disclosure;

FIG. 30 is a left side elevation view of the junction box of FIG. 24, according to one or more examples of the present disclosure;

FIG. 31 is a right side elevation view of the junction box of FIG. 24, according to one or more examples of the present disclosure;

FIG. 32 is another isometric view of the junction box of FIG. 24, from a back side of the junction box, according to one or more examples of the present disclosure;

FIG. 33 is yet another isometric view of the junction box of FIG. 24, from a left side of the junction box, according to one or more examples of the present disclosure;

FIG. 34 is a third angled elevation view of the junction box of FIG. 24, according to one or more examples of the present disclosure;

FIG. 35 is an isometric view of the junction box of FIG. 24, from a bottom of the junction box, according to one or more examples of the present disclosure;

FIG. 36 is an isometric view of a lid of the junction box of FIG. 24, showing an inside of the lid, according to one or more examples of the present disclosure;

FIG. 37 is an isometric view of a base of the junction box of FIG. 24, showing an inside of the base, according to one or more examples of the present disclosure;

FIG. 38 is yet another isometric view the junction box of FIG. 24, showing the junction box in an open configuration, according to one or more examples of the present disclosure; and

FIG. 39 is a cross-sectional right side elevation view of the hinged junction box of FIG. 24, taken along the line 39-39 in FIG. 24, according to one or more examples of the present disclosure.

### DETAILED DESCRIPTION

Reference throughout this specification to “one example,” “an example,” or similar language means that a particular feature, structure, or characteristic described in connection with the example is included in at least one example of the subject matter of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the subject matter of the present disclosure, however, absent an express correlation to indicate otherwise, an implementation may be associated with one or more examples.

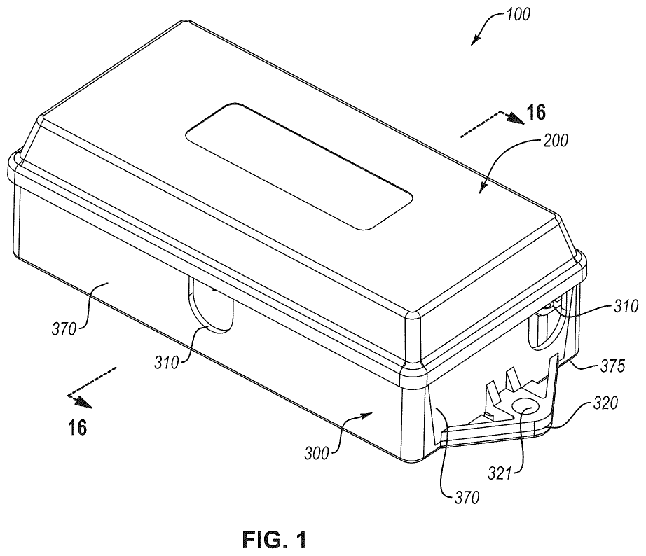

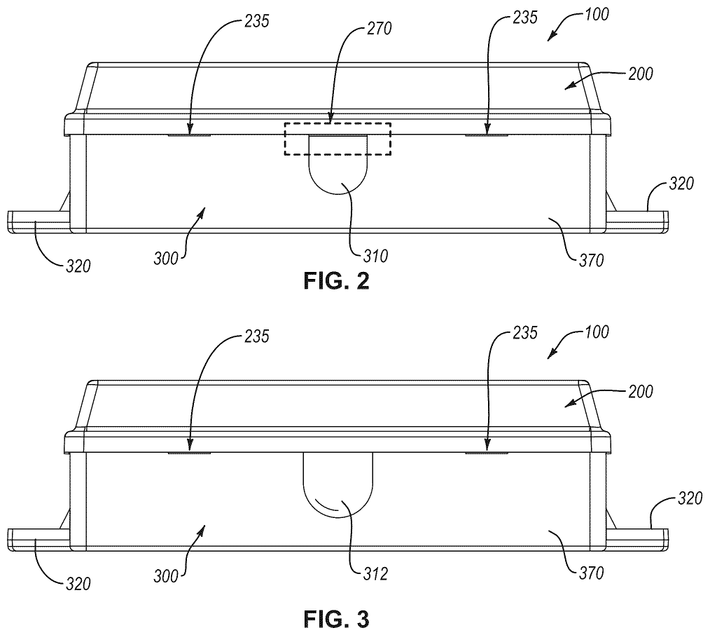

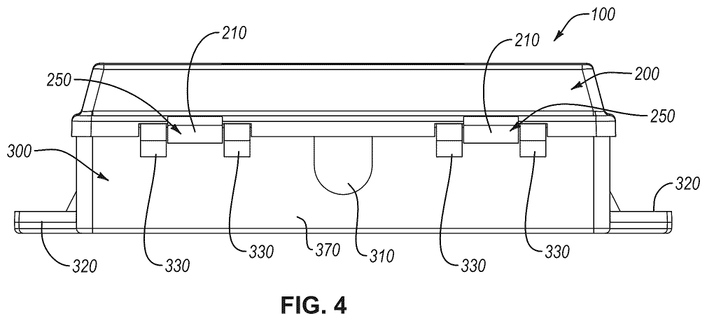

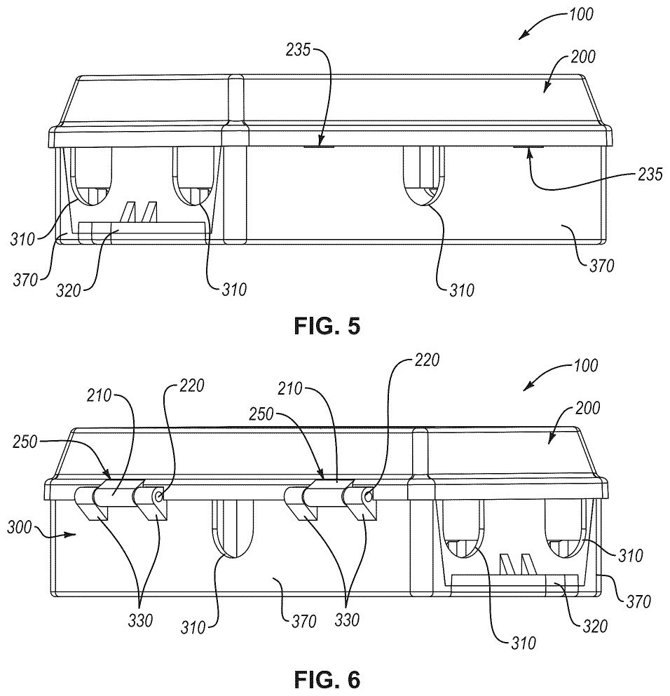

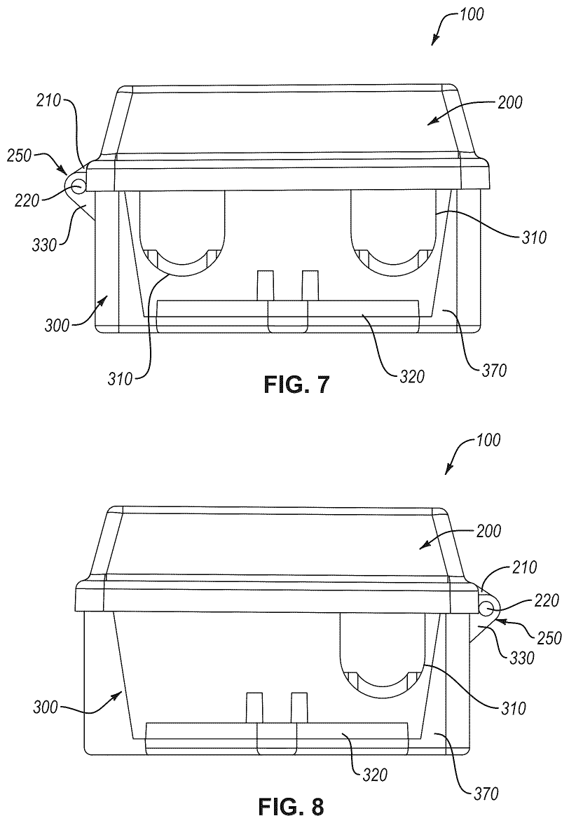

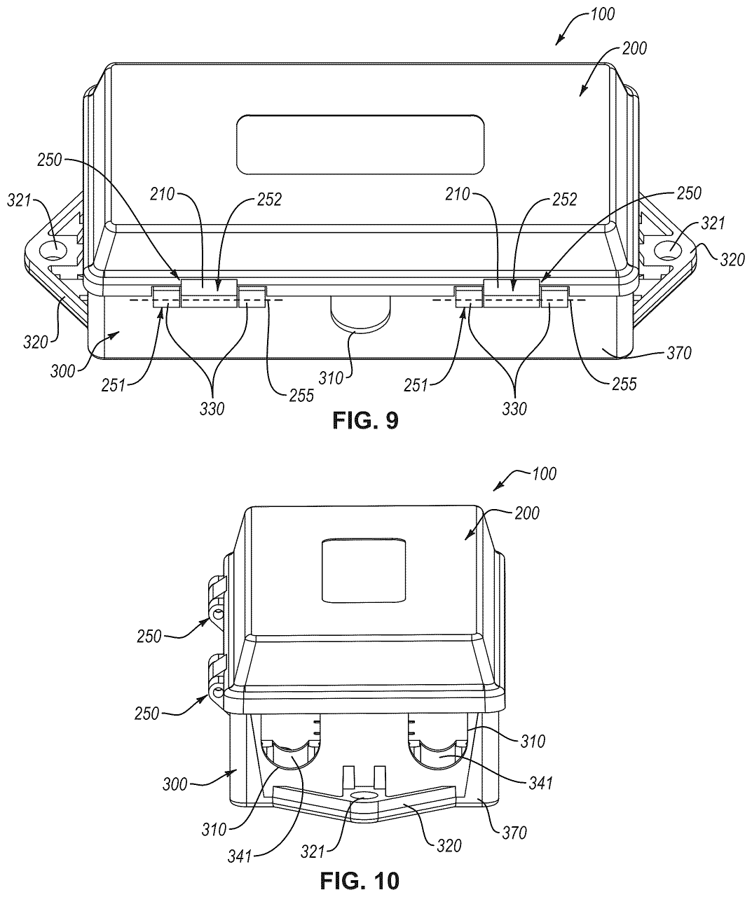

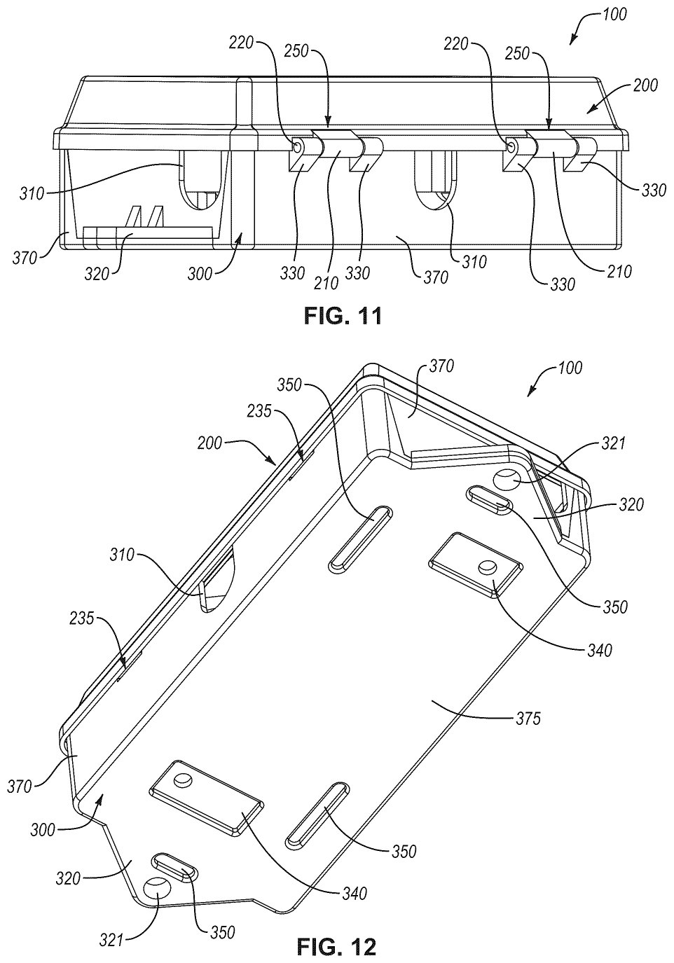

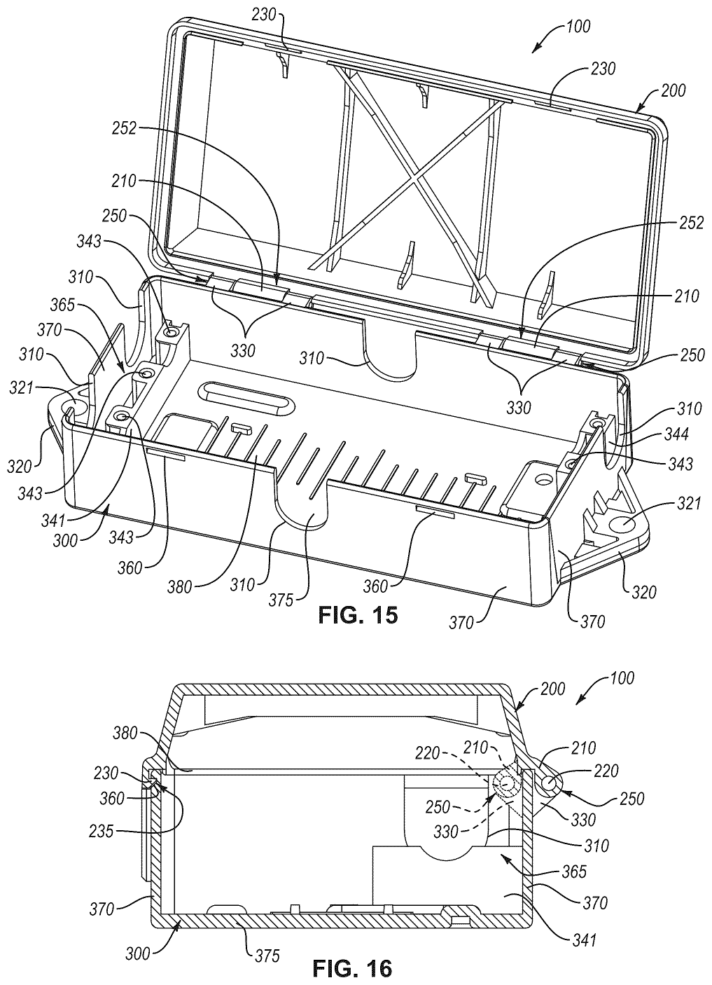

According to one example, as shown in FIGS. 1-12, a hinged junction box 100 of the present disclosure includes a base 300 and a lid 200 coupled to the base 300. The base 300 and the lid 200 collectively define an interior cavity 365 of the hinged junction box 100 (see, e.g., FIGS. 15 and 16). The hinged junction box 100 may be referred to as an enclosure or housing for securely enclosing or housing one or more wiring connections of a trailer, such as wiring connections between a trailer-interfacing portion of a trailer brake light system and a vehicle-interfacing portion of the trailer brake light system.

The base 300 defines a lower portion (e.g., lower half) of the hinged junction box 100 and has sides 370, a closed bottom 375, and an open top 380 (see, e.g., FIGS. 14-16). In the illustrated example, the base 300 has four sides 370 and the base 300 has a rectangular or square shape. However, in other examples, the base 300 can have three or more than four sides. An interior side of the closed bottom 375 provides a secure location for electrically connecting wires, or other electrical components, to trailer wiring within the hinged junction box 100.

The sides 370 of the base 300 may each have one or more holes or pass-throughs 310. The pass-throughs 310 help to accommodate the passage of wires from outside the hinged junction box 100 into the interior cavity 365 to be connected and secured to internal wiring within the hinged junction box 100. If a pass-through 310 is not used to provide passage of a wire or wires into the internal cavity 365, then the pass-through 310 can be filled with a grommet 312, as shown in FIG. 3. The grommet 312 is made of a resiliently flexible material, such as a rubber material, in one example. The base 300 and the lid 200 can be made from a rigid material, such as a hardened plastic material. The material of the base 300 and the lid 200 is harder and stiffer than the material of the grommet 312.

For pass-throughs 310 that do provide passage or a wire or wires, a rubber grommet (not shown) with a center hole can be used to facilitate the passage of the wires. In some examples, the wires are inserted into the rubber grommet before the grommet is installed in the pass-through 310. The grommets help to seal the interior cavity 365 of the hinged junction box 100 from environmental elements. In some examples, a pass-through 310 is made of a flexible material that is co-molded with the base 200 of the hinged junction box. According to certain examples, the flexible material of the grommet 310 is manufactured with a slit or circle to enable the passage of a cable or wire therethrough. In other examples, the flexible material may be manufactured without openings or slits, and a user may cut a hole or slit into the pass-through 310 should the user wish to pass a wire therethrough. In some examples, a pass-through 310 may be located on the bottom of the base 300, rather than on a side 370.

In one example, the base 300 includes external securement tabs 320. The securement tabs 320 promote attachment of the hinged junction box 100 to a surface of an object, such as the frame of a trailer, using fasteners or other coupling devices. In the illustrated example, the securement tabs 320 are fixed to a corresponding one of the sides 370 of the base 300 on an exterior surface of the sides 370 (opposite the interior cavity 365). The securement tabs 320 extend perpendicularly away from the side 370 to which the securement tabs 320 are fixed. In one example, the base 300 includes two securement tabs 320 located on opposite ends of the base 300. In some examples, each one of the securement tabs 320 includes an aperture 321 (see, e.g., FIG. 1) through which a fastener can pass to secure the base 300 to an object. In an alternate example, the base 300 does not have external securement tabs 320. In such an example, the base 300 can include internal securement points that are accessible from within the internal cavity 365, such that fasteners can engage the object through the interior cavity 365.

Referring to FIG. 12, according to some examples, the closed bottom 375 of the base 300 may have various interior and/or exterior features for accommodating attachment of the hinged junction box 100 to an external surface and/or to promote securement of wiring within the internal cavity 365. For example, the bottom 375 can include cavities 350 (e.g., cut-outs, apertures, holes, recesses, etc.) that can be filled or occupied with a dampening material, such as a foam, padding, and/or adhesive, to help cushion the base 300 against the surface to which the base is attached. In certain examples, the closed bottom 375 includes recesses 340 with apertures that enable wiring or other electrical components within the internal cavity 365 to be secured at a location external to the internal cavity 365. In one example, the recesses 340 are also filled with foam, padding, or sealing material to isolate the hardware of the wiring from the environment and/or to help cushion the base 300 against the surface of the object to which the base 300 is attached.

In some examples, such as shown in FIGS. 14 and 15, the base 300 includes wire tensioners 341 within the internal cavity 365. The wire tensioners 341 are fixed to and extend uprightly from the closed bottom 375. Each one of the wire tensioners 341 is spaced apart from and aligned with a respective one of the pass-throughs 310. More specifically, in some examples, each one of the wire tensioners 341 includes channel 342 that has a curved shape, which corresponds with (e.g., is the same as) the curved shape of the respective one of the pass-throughs 310. The channels 342 are parallel to the respective ones of the pass-throughs 310, and, in some examples, each one of the channels 342 is vertically aligned with the corresponding one of the pass-throughs 310 (e.g., each one of the channels 342 is located at the same height from the closed bottom 375 as the corresponding one of the pass-throughs 310). Additionally, each one of the wire tensioners 341 includes a receptacle 343 on each side of the channels 342, such that the channel 342 of each one of the wire tensioners 341 is interposed between the receptacles 343 of the corresponding one of the wire tensioners 341. Although not shown, the wire tensioners 341 also include corresponding hardware, such as brackets, that are fixed to the receptacles 343 via fasteners. When fastened to the receptacles 343, the hardware helps to clamp down on a cable received within the channel 342 to maintain the cable within the channel 342.

As mentioned, the wire tensioners 341 help to maintain tension in cables (e.g., the cables 420) that pass through the pass-throughs 310 and enter the interior cavity 365 to be electrically connected to one or more various electrical connections within the interior cavity 365. Maintaining the cables in tension near the location through which the cables enter the interior cavity 365 helps to ensure the electrical connections between the cables and the various electrical connections within the interior cavity 365 are strong and reliable, even when the cables are moved around or vibrate at locations external to the interior cavity 365.

In a closed position (see, e.g., FIGS. 1-12), the lid 200 of the hinged junction box 100 is engageable with the open top 380 of the base 300 to enclose the interior cavity 365. When the lid 200 is in the closed position, a seal is formed between an engagement groove 240 of the lid 200 and the base 300 to help prevent moisture and other contaminants from entering the interior cavity 365. In one example, all sides of the lid 200 and the base 300 of the hinged junction box 100 engage with one another to form a secure enclosure. Accordingly, the engagement groove 240 can extend around an entire perimeter of the lid 200 and match the size and shape of the perimeter or rim of the open top 380 of the base 300. In another example, only one side of the base 300 and one side of the lid 200 engage to form the secure enclosure. In yet another example, multiple sides of the base 300 and the lid 200 engage to form the secure enclosure, but not all sides engage. In some examples, a gasket or an o-ring is placed along the engagement groove 240 of the lid 200 to promote a seal between the lid 200 and the base 300 when the lid 200 is in the closed position.

The lid 200 and the base 300 also include corresponding lid retention features, such as a latch or other securement connection 235, to promote selective releasable retention of the lid 200 to the base 300 when the lid 200 is in the closed position. In one example, the lid 200 and the base 300 include a respective one of, and are secured together by, a tongue and groove of a tongue-and-groove connection. Referring to FIGS. 15 and 16, the lid 200 includes a base engagement feature 230 (e.g., tongue), of the securement connection 235, and the base 300 has a lid engagement feature 360, of the securement connection 235. The lid engagement features 360 can be a recess or groove configured to receive the base engagement feature 230. As shown in the cross-sectional view of FIG. 16, the base engagement feature 230 fits tightly within the lid engagement feature 360 when the lid 200 is in the closed position to secure the lid 200 in the closed position. The secure engagement is released when the base engagement feature 230 is flexed outwardly via an opening force applied by a user and pulled out of the lid engagement feature 360, such as when the lid 200 is opened into an open position (e.g., FIG. 15) from the closed position. In another example, the securement connection 235 includes a latch, where the lid 200 includes a hook which engages with a lip or extrusion of the base 300, or vice versa. In another example, the latch is a cam latch where the base 300 has a twist or key to rotate the cam and lock behind the lid 200. In another example, the latch is a toggle latch to form a tight seal when the box is closed. The securement connection 235 may include any type of latch or closing mechanism.

In some examples, to help prevent unauthorized access to the interior cavity 365, the lid 200 and base 300 can be further secured together when the lid is in the closed position by an external locking mechanism 270, such as a pad lock. In one example, the lid 200 and base 300 each have a corresponding one of a tab and receptacle that are mated and are capable of receiving the external locking mechanism. In yet another example, the hinged junction box 100 includes an integrated locking mechanism. Corresponding first and second portions of the integrated locking mechanisms are integrated into the lid 200 and the base 300, respectively. The first and second portions engage each other to prevent unauthorized access. In one example, the first portion is a hook that is built into the lid 200 of the hinged junction box 100 and the second portion is a latch that is built into the base 300 of the hinged junction box 100, or vice versa. The latch is secured to the hook to lock the lid 200 to the base 300, and can be unsecured from the hook via a key accessible only by an authorized user of the hinged junction box 100

The hinged junction box 100 further includes a hinge 250. The lid 200 is openable between, and inclusive or, the closed position (see, e.g., FIGS. 1-12), in which the interior cavity 365 is not accessible through the open top 380 of the base 300, and the open position (see, e.g., FIG. 15), in which the interior cavity 365 is accessible through the open top 380, via operation of the hinge 250. The hinge 250 prevents the lid 200 from being decoupled from the base 300 and enables the lid 200 to pivot relative to the base 300 along a rotational axis 255 defined by the hinge 250.

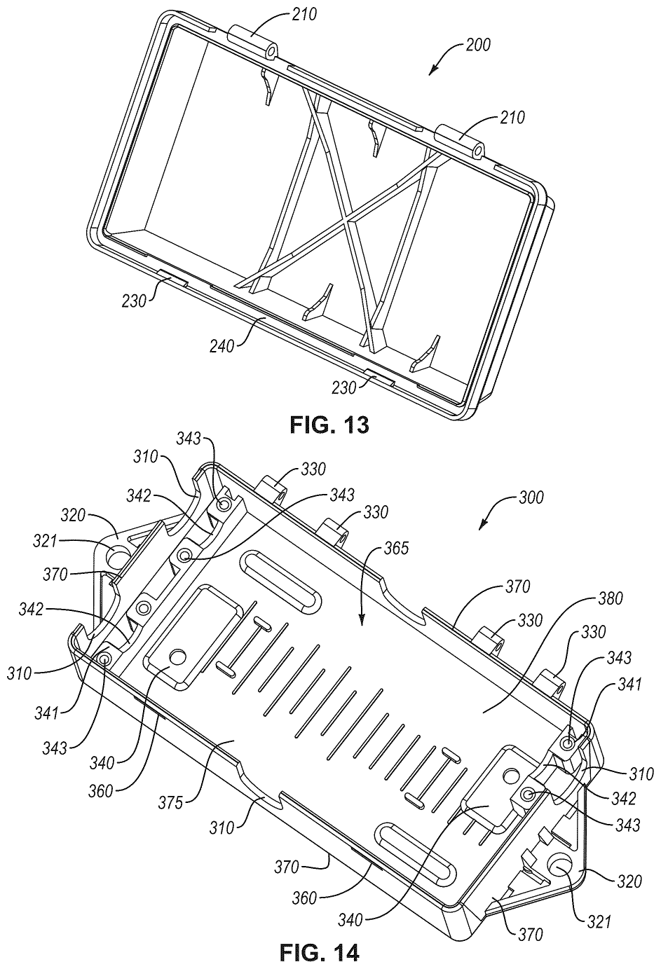

In the illustrated examples (FIGS. 1-16), the hinged junction box 100 includes two hinges 250, each of which include a base portion 251 and a lid portion 252. However, in other examples, the junction box 100 can include any number of hinges 250, such as one or more than two.

In one example, the base portion 251 includes two spaced-apart base knuckles 330 and the lid portion 252 includes a lid knuckle 210. The base knuckles 330 are engaged with (e.g., straddling) the lid knuckle 210 to enable rotational movement of the lid 200 relative to the base 300. Each of the base knuckles 330 and the lid knuckle 210 defines a channel. When the channels are aligned, a pin 220 extends through the channels to couple together the base knuckles 330 and the lid knuckle 210, and to enable rotation between the lid 200 and the base 300. The pin 220 defines the rotational axis 255 of the hinge 250. In the illustrated examples, the base portion 251 of the hinges 250 is co-molded and forms a one-piece construction with the base 300, and the lid portion 252 is co-molded and forms a one-piece construction with the lid 200.

In an alternative example, the hinge 250 is separately formed and attached to the side of the base 300 and the lid 200. The hinge 250 may be attached to the base 300 and the lid 200 via any of various attachment techniques, such as via fasteners, welds, adhesives, etc. In yet another example, the hinge 250 is co-formed with one of the base 300 or the lid 200, and separately attached to the lid 200 or the base 300, respectively. As an alternative to the pin-knuckle hinge described above, the hinge 250 may be another type of hinge, such as a ball hinge, a bullet hinge, or a leaf hinge. Additionally, in some examples, instead of being located externally relative to the interior cavity 365, the hinge 250 can be located within the interior cavity 365, as shown in dashed lines of FIG. 16. A hinge 250, located within the interior cavity 365, although taking up space within the internal cavity 365, also provide additional security by preventing damage to the hinge 250 or unwanted manipulation of the hinge 250.

Although the above examples of the hinge 250 include at least two separate, but attachable, portions, in another example, the hinge 250 has a one-piece monolithic construction. For example, the hinge 250 can be co-molded as a single piece with the base 300 and the lid 200. In such an example, the hinge 250 can be a thinner section of plastic spanning between the base 300 and the lid 200, which can be flexed to enable opening and closing of the lid relative to the base.

In some examples, the hinged junction box 100 includes features that restrict or limit the pivoting of the lid 200 relative to the base 300. In some examples, the hinged junction box includes a biasing element coupled between the lid 200 and the base 300. The biasing element is configured to bias the lid 200 in the closed position. The lid 200 can be opened by applying an opening force to the lid 200 that overcomes the bias of the biasing element. Biasing the lid 200 in the closed position can be helpful, such as to keep the lid 200 closed if the securement connection 235 of the hinged junction box 100 were to get damaged. Examples of a biasing element include a tension spring or another similar device. In some examples, the hinged junction box 100 includes a stop that limits or prevents pivoting of the lid 200 away from the closed position beyond a predetermined amount. According to one example, the stop, which can form part of the lid 200 and/or the base 300, is configured to prevent pivoting of the lid 200 beyond 90 degrees from the closed position.

The hinged connection between the lid and base of the hinged junction box 100 provides numerous advantages compared to conventional junction boxes. Conventional junction boxes have lids that entirely separate from the base and require multiple fasteners that extend through and fix the lid to the base. The fasteners take up valuable space, which limits the capacity of the junction box and requires a larger junction box for the same amount of electrical connections. Also, being entirely separable from the base, the lid can be easily misplaced or damage, and requires a storage location, when the junction box is being accessed. With the hinged junction box 100 of the present disclosure, a user does not have to be concerned with potential misplacement of or damage to the lid 200 because they are hingedly connected to one another. A user of the hinged junction box 100 of the present disclosure also does not have to worry about potential stripping the fasteners when securing the lid 200 to the base 300 of the hinged junction box 100 once the wires have been connected. Alternatively, a user does not need to worry about misplacing fasteners when resecuring the lid to the base of the hinged junction box 100, as is the case with conventional junction boxes. Additionally, a user does not need to have various external tools to remove the fasteners in order to open the hinged junction box 100 to inspect the wiring connections of the hinged junction box 100.

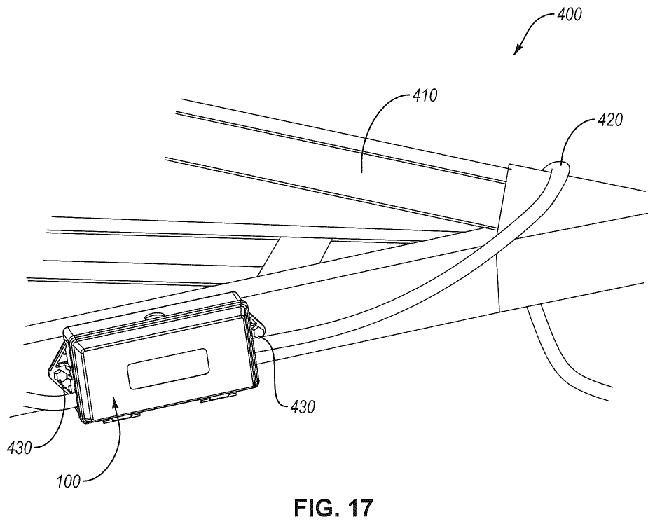

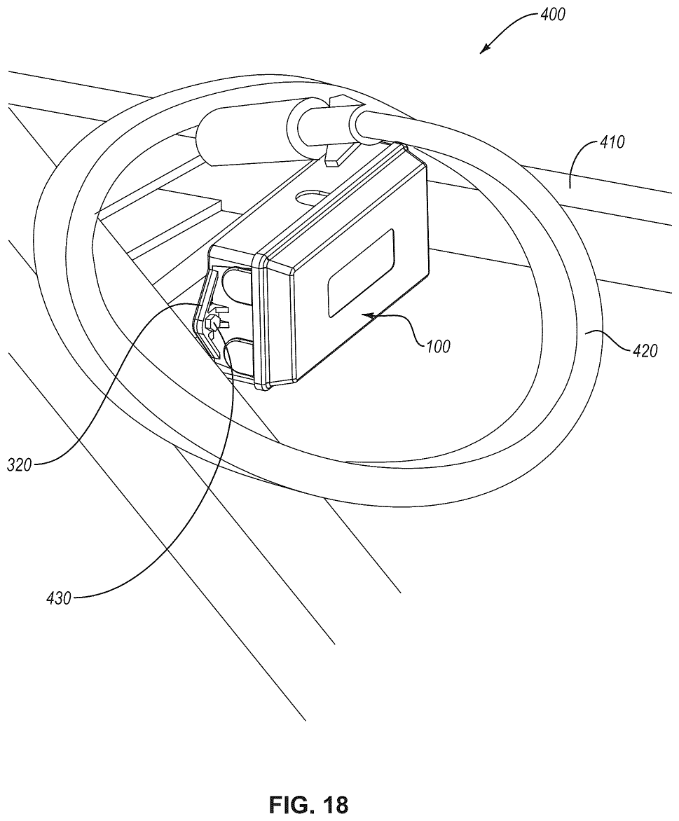

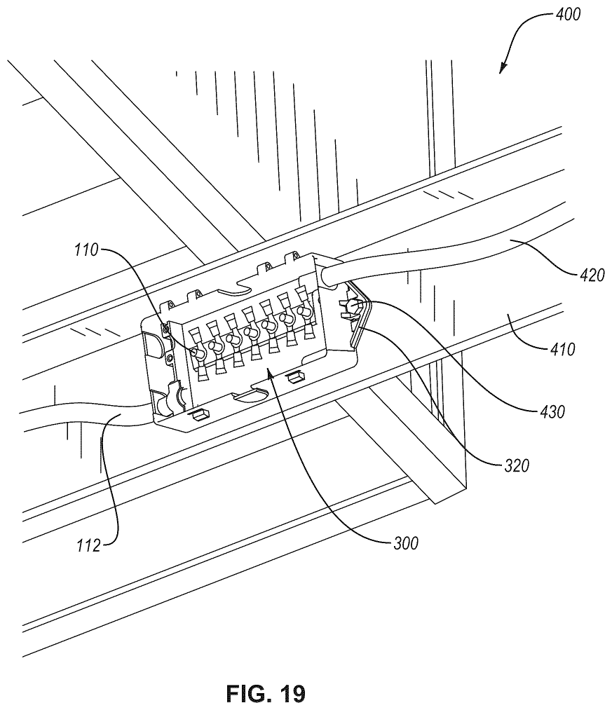

FIGS. 17-19 illustrate examples of a system 400 that includes the hinged junction box 100, a trailer 410, and two cables 420 of a trailer wiring harness. The hinged junction box 100 is secured to a frame of the trailer 410 by fasteners passing through the securement tabs 320 of the hinged junction box 100 and engaging the frame of the trailer 410. As shown in FIG. 17, the hinged junction box 100 may be secured to an outward surface of the trailer 410 and located at an outer location on the trailer 410. In another example, as shown in FIG. 18, the hinged junction box 100 may be secured to an inward surface of the trailer 410 and located at an inner location on the trailer 410. In yet another example, as shown in FIG. 19, the hinged junction box 100 is secured by the securement tabs 320 to an underside of the trailer 410. The hinged junction box 100 may be located anywhere on the trailer 410, including the trailer frame, in which the hinged junction box 100 can be safely secured to the trailer 410. In some examples, the system 400 includes the vehicle that is coupled to and configured to tow the trailer 410.

FIG. 19 illustrates an example of the wire connections 110 within the hinged junction box 100 when the hinged junction box 100 is fixed to the trailer 410. One set of the wire connections 110 come from the cable 112 which houses the wiring for the electrical components of the trailer. The other set of wires of the wire connections 110 are from a cable 420, which forms part of a wiring harness and is used to connect the trailer electronic to a separate exterior towing vehicle, such as a truck, car, or sport utility vehicle (SUV).

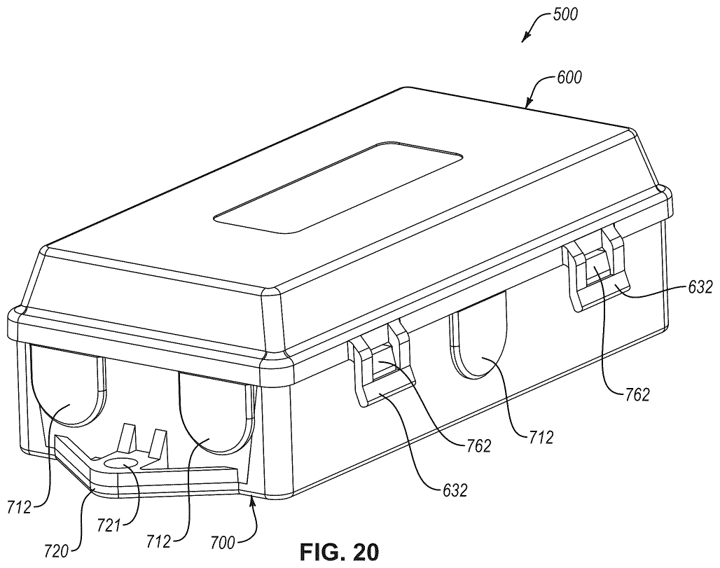

FIGS. 20-23 illustrate another example of a hinged junction box 500 of the present disclosure. The hinged junction box 500 includes a base 700 and a lid 600 pivotally coupled to the base 700, similar to the hinged junction box 100. More specifically, the features of the hinged junction box 500 directly correspond to the features of the hinged junction box 100 having like numbers, but in a different series (e.g., 500-series, 600-series, and 700-series, instead of 100-series, 200-series, and 300-series). Accordingly, unless otherwise noted, the features of the lid 600 and the base 700 are the same as or similar to the corresponding features of the lid 200 and the base 300 (e.g., the lid knuckle 610 is substantially the same as the lid knuckle 210, and base knuckle 730 is substantially the same as the base knuckle 230).

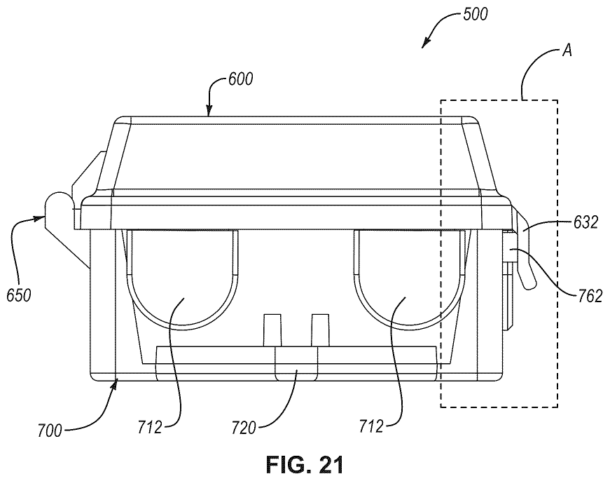

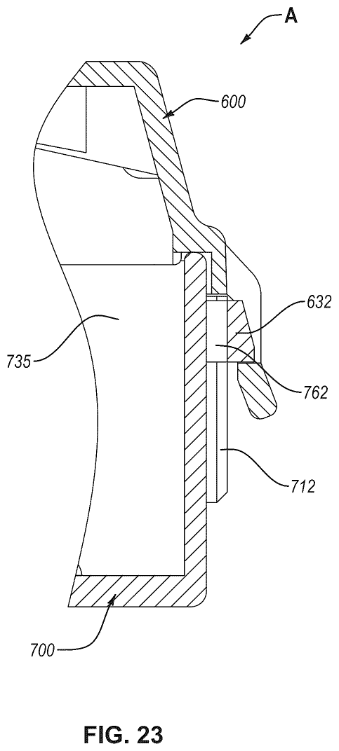

In one example, the lid 600 of the hinged junction box 500 is secured to the base 700 by a single latch system. In alternative examples, as shown, the lid 600 of the hinged junction box 500 is secured to the base 700 by a dual latch system. As shown in FIGS. 20 and 21, the lid 600 includes two latch fasteners 632 of a dual latch system. Each one of the latch fasteners 632 interacts with a corresponding one of two latch tabs 762 of the base 700 to create a secure and selectively releasable coupling between the lid 600 and the base 700. Although two latch-fastener and latch-tab pairs are shown, in other examples, one or more than two latch-fastener and latch-tab pairs can be used. In some examples, each one of the latch fasteners 632 includes a hook that is configured to be secured to the corresponding one of the latch tabs 762 in a hooking engagement. In one example, the hook of the latch fastener 632 engages a bottom of a latch tab 762, as shown in FIG. 23. In alternative examples, each one of the latch tabs 762 includes an opening for a hook of a corresponding one of the latch fasteners 632 to be secured therein. The latch fasteners 632 may have any of various shapes and designs. In one example, the latch fasteners 632 are shaped to provide a user with an easy-to-grab user-engagement portion. In some examples, the latch fasteners 632 have a monolithic construction with other features of the lid 600. In alternative examples, the latch fasteners 632 can be attached, adhered, or fastened to the exterior of lid 600.

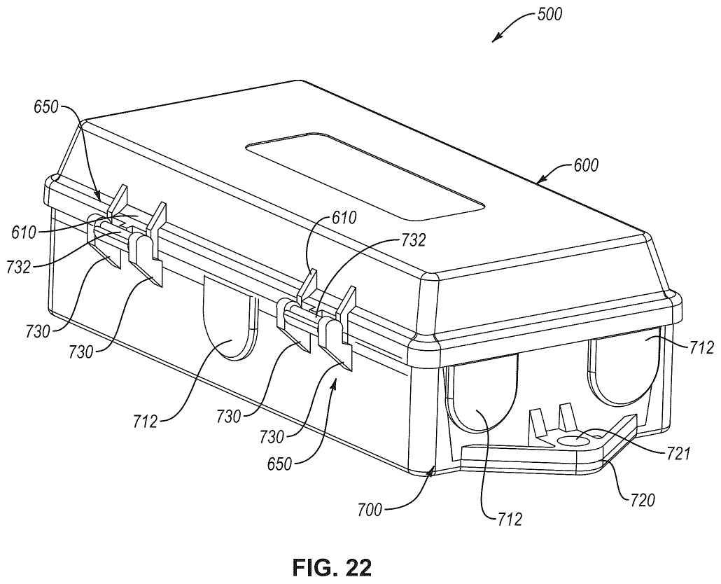

In the illustrated examples of FIGS. 20-22, the hinged junction box 500 has two hinges 650 each of which include a base portion and a lid portion respectfully. However, in other examples, the hinged junction box 500 may include any number of hinges 650. In one example, as shown in FIG. 22, the base 700 includes two spaced-apart base knuckles 730 that are engaged with corresponding lid knuckles 610 to enable pivotal movement of the lid 600 relative to the base 700. Each one of the base knuckles 730 is connected to the corresponding one of the lid knuckles 610 a bar 732. The bar 732 defines the rotational axis of the hinge 650. In certain examples, the lid knuckles 610 are shaped to wrap around a corresponding one of the bars 731 and enable rotation between the lid 600 and the base 700.

In some examples, the lid 600 is removable from the base 700 to permit replacements and extend the life of the hinged junction box 500. In some examples, the lid 600 may be removed from the base 700 at the hinge 650 by removing the pins. In some examples, the pin of hinge 650 may be replaced as well if there has been damage to the pin.

In some of the various examples of the hinged junction boxes disclosed above, the lid of the hinged junction box includes certain features that are engageable with certain features of the base. It is recognized that in various alternative examples, the certain features of the lid and the certain features of the base can be reversed while still enabling the same engagement between the lid and the base. As one example, the hinge of the hinged junction box may include two spaced-apart knuckles on the lid and one knuckle on the base.

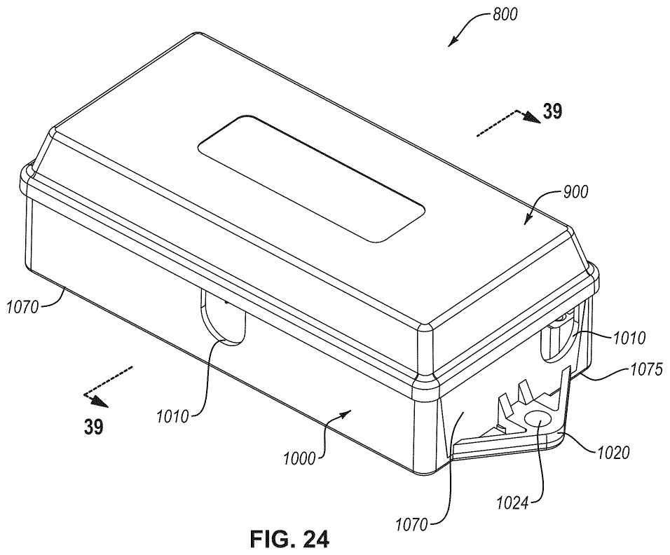

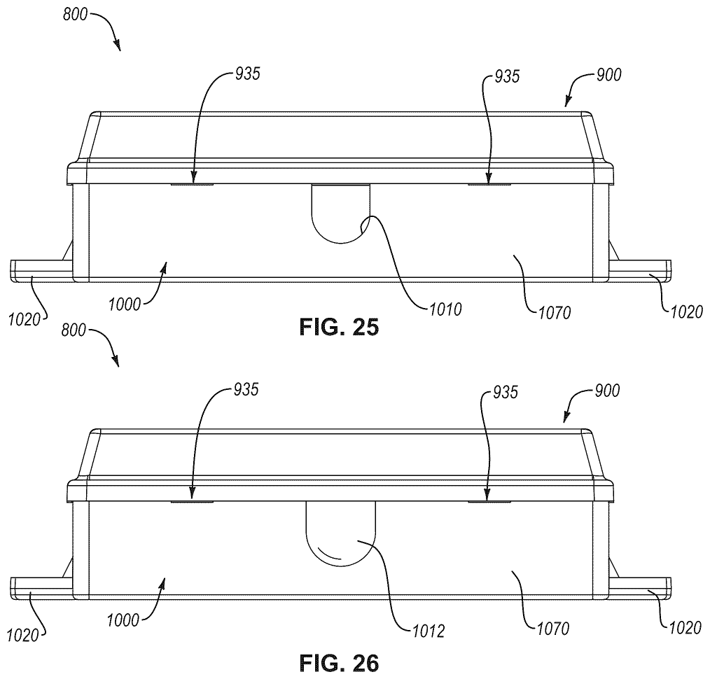

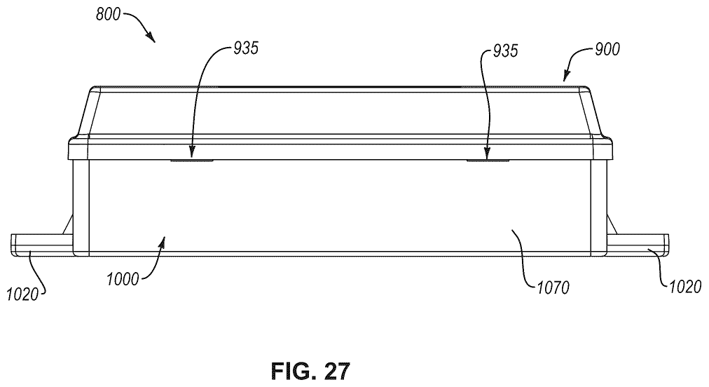

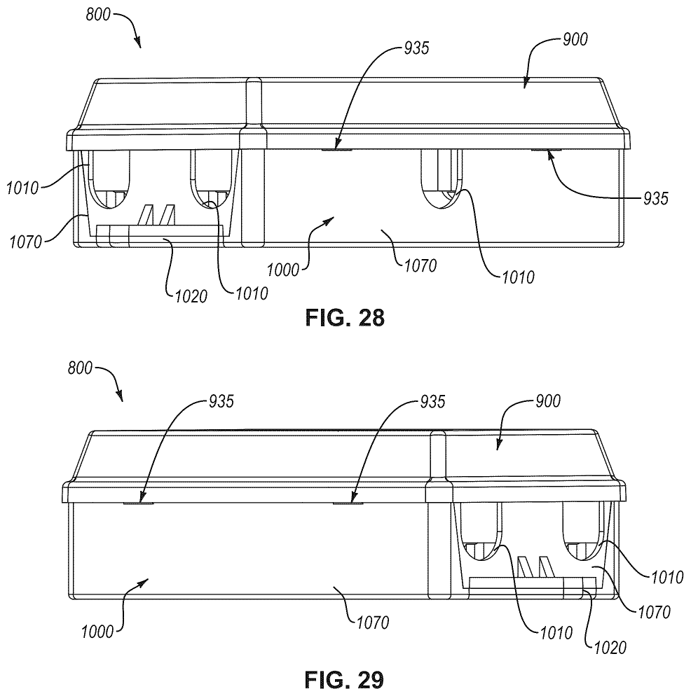

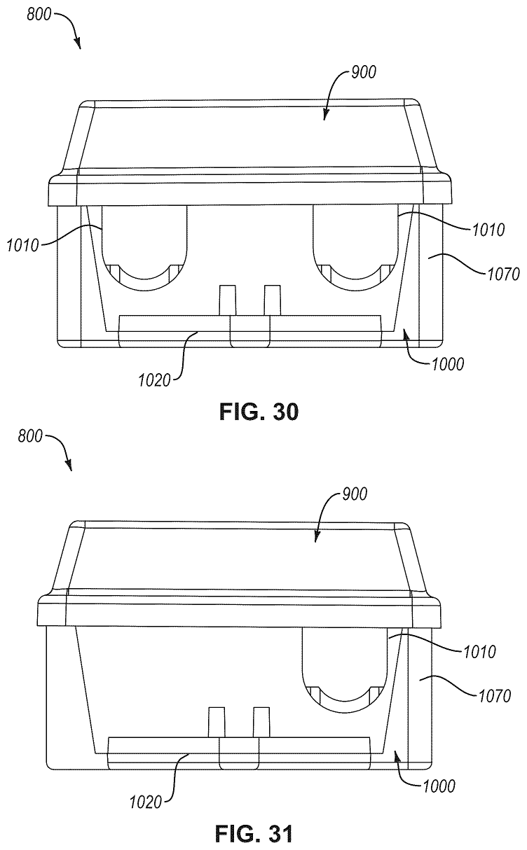

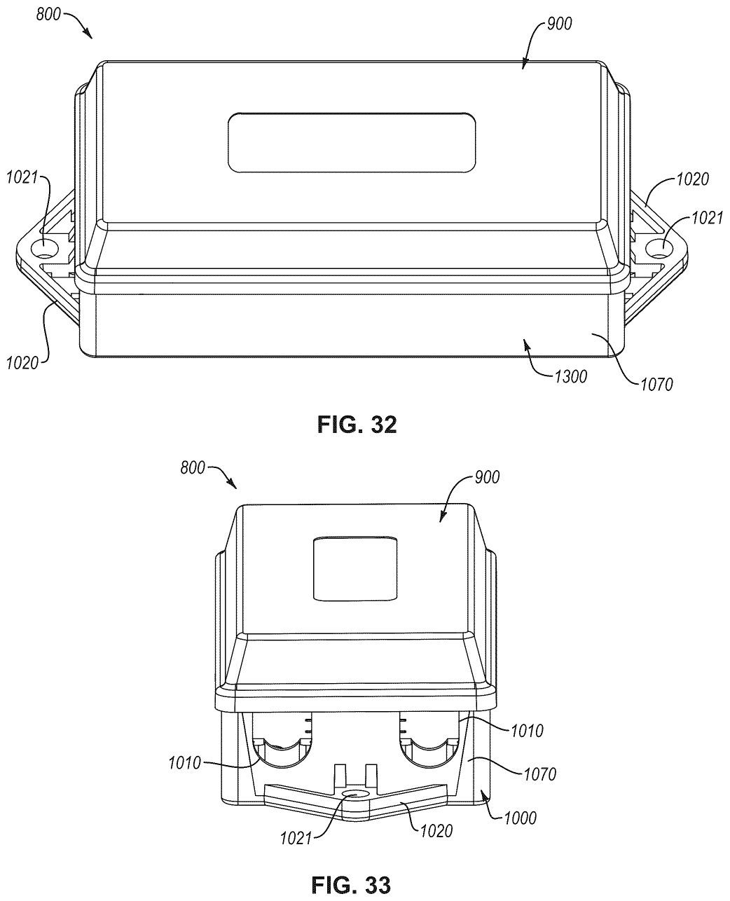

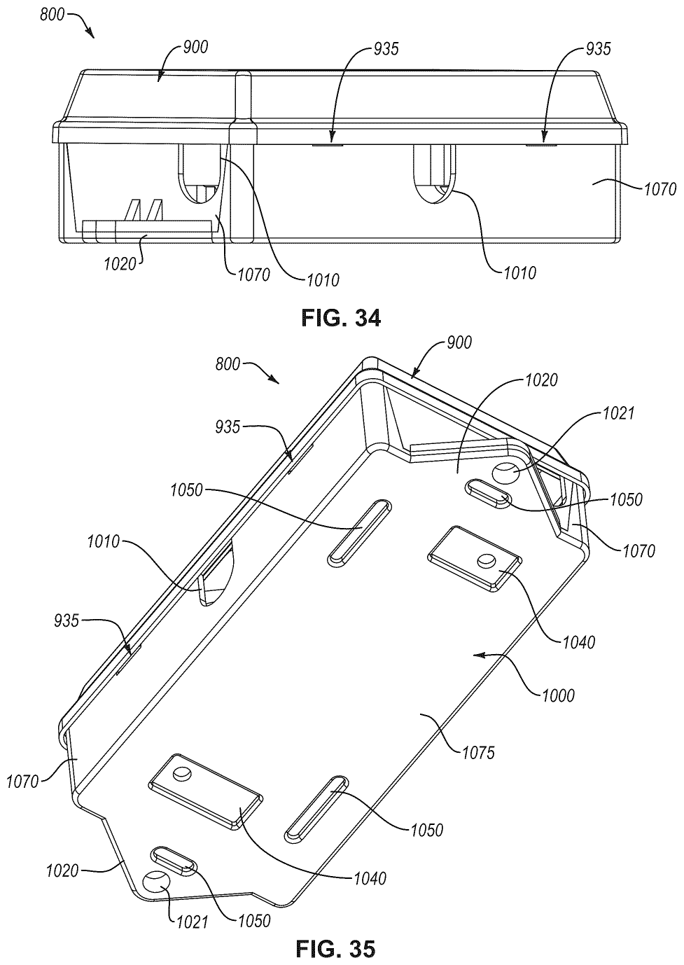

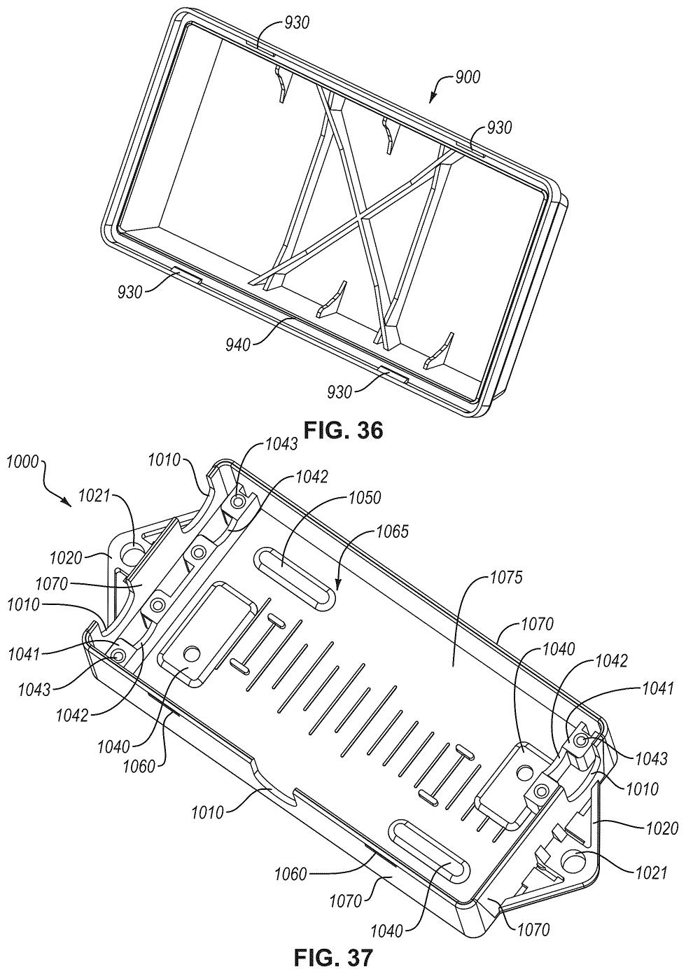

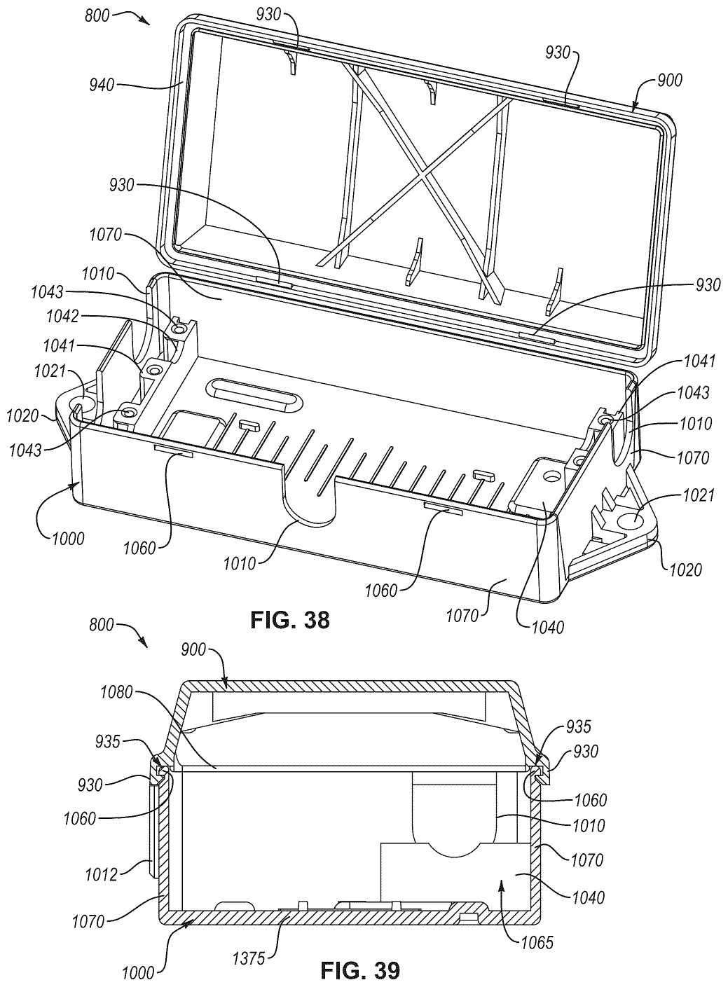

FIGS. 24-39 illustrate another example of a junction box 800 of the present disclosure. The junction box 800 includes a base 1000 and a lid 900, but in contrast to the hinged junction boxes 100 and 500, the junction box 800 does not include a hinge. The remaining features of the junction box 800 directly correspond to the features of the hinged junction box 100 having like numbers, but in a different series (e.g., 800-series, 900-series, and 1000-series, instead of 100-series, 200-series, and 300-series). Accordingly, unless otherwise noted, the features of the lid 900 and the base 1000 are the same or similar to the corresponding features of the lid 200 and the base 300 (e.g., the lid engagement feature 1060 of base 1000 is substantially the same as the lid engagement feature 360 of base 300, and base engagement feature 930 of the lid 900 is substantially the same as the base engagement feature 230 of the lid 200).

As shown in FIGS. 24-39, the junction box 800 does not include a hinge. Instead, the junction box 800 includes at least one set of a lid engagement feature 1060 and a base engagement feature 930 on at least two opposing sides of the junction box 800. In the illustrated examples, the base 1000 includes four lid engagement features 1060 (e.g., two on each of the opposing sides, e.g., the front and the back sides of base 1000) and the lid 900 includes four base engagement features 930 (e.g., two on each of the opposing sides, e.g., the front and the back sides of the lid 900). Each one of the base engagement features 930 is configured to engaged a corresponding one of the lid engagement features 1060 to selectively retain the lid 900 to the base 1000. In some other examples, the base 1000 includes at least one lid engagement feature 1060 on each of the four sides of the base 1000, and the lid 900 has a corresponding base engagement feature 930 on each side of the lid 900.

Like the junction box 100, the lid 900 can be secured to the base 1000 without fasteners, such as fasteners that pass through the lid, the base, and into a trailer. However, because the junction box 800 does not have a hinged connection, the lid 900 can be separated from the base 1000 when not in use, which can enable more efficient access to the base 1000 for initializing or maintaining trailer electrical connections within the base 1000.

Although not illustrated, the lid 900 of the junction box 800 may be secured to the base 1000 by a latch system. In some examples, at least two opposing sides of the junction box 800 have a single latch system. In other examples, each side of the junction box 800 has a single latch system. Alternatively, at least two opposing sides of the junction box 800 is secured by two latch fasteners per side. As previously described above, the latch fasteners may have any of a variety of shapes and designs.

In the above description, certain terms may be used such as “receiving,” “inserting,” “attaching,” “connecting,” and the like. These terms are used, where applicable, to provide some clarity of relationships. But, these terms are not intended to imply absolute relations. Rather, these terms may be interchangeable with one another.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

The term “about” or “substantially” or “approximately” in some embodiments, is defined to mean within +/−5% of a given value, however in additional embodiments any disclosure of “about” or “substantially” or “approximately” may be further narrowed and claimed to mean within +/−4% of a given value, within +/−3% of a given value, within +/−2% of a given value, within +/−1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

The subject matter of the present disclosure may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A junction box for housing wiring of a trailer, the junction box comprising:
a base, within which the wiring is securable, wherein the base comprises a closed bottom, at least three sides connected to the closed bottom, an open top, and a lid engagement feature, and wherein at least one of the at least three sides comprises one or more wire pass-throughs; and
a lid, comprising a base engagement feature that is selectively releasably engageable with the lid engagement feature of the base to prevent the lid from opening relative to the base and to enclose an interior cavity of the junction box when the lid is in a closed position.

2. The junction box of claim 1, wherein the lid engagement feature comprises one of a tongue or a groove of a tongue-and-groove coupling, and the base engagement feature comprises another one of the tongue or the groove of the tongue-and-groove coupling.

3. The junction box of claim 1, wherein:
the base engagement feature comprises at least one latch of a latch coupling; and
the lid engagement feature comprises at least one catch of the latch coupling.

4. The junction box of claim 1, further comprising a hinge pivotally coupling the lid to the base, such that the lid is pivotable relative to the base between, and inclusive of, the closed position and an open position, in which the interior cavity is not enclosed.

5. The junction box of claim 2, wherein the lid engagement feature is one of a tongue or a groove of a tongue-and-groove coupling, and the base engagement feature is another one of the tongue or the groove of the tongue-and-groove coupling.

6. The junction box of claim 2, wherein the base engagement feature is at least one latch of a latch coupling, and the lid engagement feature is at least one catch corresponding to the at least one latch of the base engagement feature the pair combine to form a latch coupling.

7. The junction box of claim 2, further comprising a locking mechanism configured to selectively lock the lid in the closed position.

8. The junction box of claim 2, wherein the hinge comprises:
a base knuckle fixed to the base and comprising a first channel;
a lid knuckle fixed to the lid and comprising a second channel; and
a pin extending through the first channel and the second channel to pivotally couple together the base knuckle and the lid knuckle, wherein the pin defines a rotational axis of the hinge.

9. The junction box of claim 2, wherein:
the hinge forms a one-piece monolithic construction and is co-molded with the base and the lid; and
the hinge spans from the base to the lid and comprises a flexible material that flexes as the lid pivots relative to the base.

10. The junction box of claim 1, wherein the base further comprises at least one external securement tab configured to secure the junction box to a vehicle trailer.

11. The junction box of claim 10, wherein the at least one external securement tab extends perpendicularly from at least one wall of the base.

12. The junction box of claim 1, further comprising a grommet fixed within each one of at least one of the pass-throughs.

13. The junction box of claim 1, wherein the base further includes at least one wire tensioner within the interior cavity.

14. The junction box of claim 10, wherein the at least one wire tensioner includes at least one channel, which corresponds to the shape of the corresponding pass through and is vertically aligned with the corresponding pass through.

15. The junction box of claim 1, further comprises a gasket positioned within the engagement groove.

16. A system, comprising:
a vehicle trailer, having at least one set of electrical components;
a junction box, coupled to the vehicle trailer and comprising:
a base, within which the wiring is securable, wherein the base comprises a closed bottom, at least three sides connected to the closed bottom, and an open top, and wherein at least one of the at least three sides has one or more wire pass-throughs;
a lid, engageable with the open top of the base to enclose an interior cavity of the junction box;
a lid-base retention system comprising a lid engagement feature and a base engagement feature, wherein the lid engagement feature and the base engagement feature of the lid-base retention system are selectively releasably engageable to prevent the lid from opening relative to the base and to enclose the interior cavity when the lid is in the closed position; and
trailer electrical components within the interior cavity; and
at least one electrical cable passing through a corresponding one of the wire pass-throughs and electrically connected to at least one of the trailer electrical components.

17. They system of claim 16, wherein the junction box further comprises a hinge rotatably coupling the lid to the base, such that the lid is rotatable relative to the base between, and inclusive of, a closed position, in which the lid is engaged with the open top of the base.

18. The system of claim 17, wherein the hinge of the junction box comprises:
a base knuckle fixed to the base and comprising a first channel;
a lid knuckle fixed to the lid and comprising a second channel; and
a pin extending through the first channel and the second channel to pivotally couple together the base knuckle and the lid knuckle, wherein the pin defines a rotational axis of the hinge.

19. The system of claim 16, wherein:
the lid engagement feature is one of a tongue or a groove of a tongue-and-groove coupling; and
the base engagement feature is another one of the tongue or the groove of the tongue-and-groove coupling.

20. A method for housing a trailer wiring system, the method comprising:
moving a lid of a junction box away from an open top of a base of the junction box into an open position, wherein in the open position, an interior cavity of the junction box is accessible through the open top of the base;
inserting a cable through a pass-through formed in the base;
securing the cable to a wire tensioner of the base, which is located within the interior cavity of the junction box;
moving the lid toward the base of the junction box, from the open position to a closed position, wherein in the closed position the interior cavity of the junction box is not accessible through the open top of the base; and
engaging a lid engagement feature of the base and a base engagement feature of the lid when the lid is in the closed position to selectively releasably retain the lid in the closed position relative to the base.
